(19) United States
(12) Patent Application Publication
(10) Pub. No.: US 2004/0229007 A1
(43) Pub. Date: Nov. 18, 2004

(54) Infilled artificial surface with natural grass-like play characteristics

(76) Inventors: Joseph E. Motz, Cincinnati, OH (US); Mark A. Heinlein, Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 10/682,442

(22) Filed: Oct. 9, 2003

Related U.S. Application Data
(60) Provisional application No. 60/453,695, filed on Oct. 9, 2002.

(51) Int. Cl. B32B 33/00; B32B 3/02; D04H 11/00

(52) U.S. Cl. 428/92; 428/85; 428/95; 428/87; 428/97

(57) ABSTRACT

An infilled artificial surface has natural grass-like play characteristics due to the use of two distinct groups of fibers extending upwardly from a backing, and a stabilizing fill material residing on the backing, with a first upper group of fibers simulating grass plants and extending above the infill and a second lower group of preferably texturized fibers extending upward from the backing to the top of, but not above, the fill. With this structure, substantially all of the fill material is stabilized within the vertical level of the second lower group of fibers. This second group of fibers “locks” the fill material in place and helps to promote consistent and uniform play characteristics which closely simulate natural grass, with a “foot feel” of natural turf. This structure also improves the durability of this playing surface, compared to prior infilled surfaces.

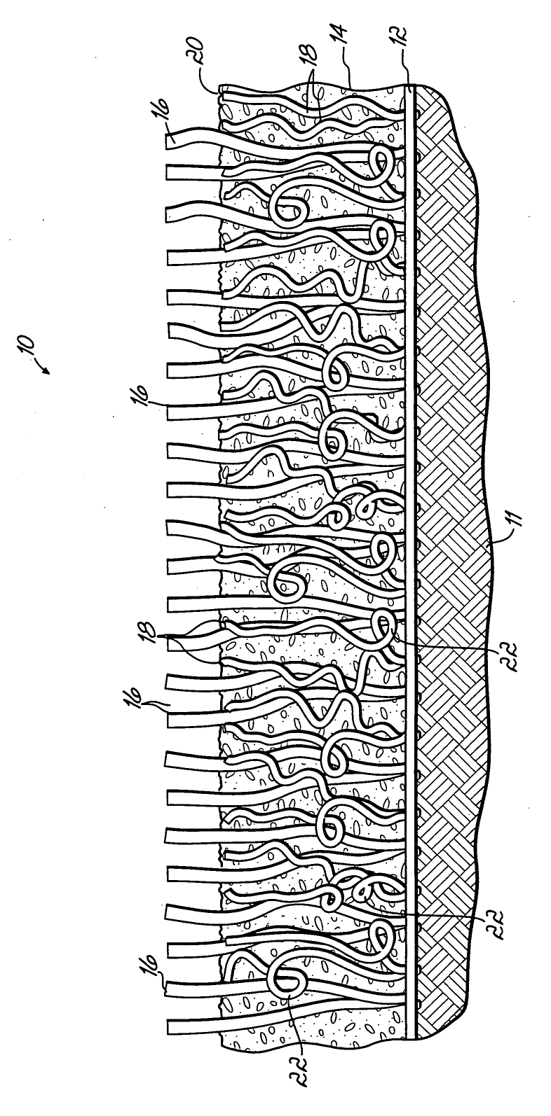

### CROSS-REFERENCE TO RELATED APPLICATIONS

The present application claims benefit of U.S. provisional application Ser. No. 60/453,695, filed Oct. 9, 2002, the disclosure of which is hereby incorporated herein by reference in its entirety.

### BACKGROUND OF THE INVENTION

A healthy, well-maintained natural turf is the ideal athletic playing surface for an athletic field. A well-maintained natural turf has familiar play and uniform characteristics, and an inherent ability to absorb shock. However, for years many athletes and groundskeepers have recognized that there are also some inherent problems with natural turf fields. More specifically, natural turf requires rain, sun, time to grow and to replenish itself, and a significant amount of maintenance. As the “playing time,” or use, of a grass field increases, the grass plants become more damaged due to wear. Under ideal conditions, natural grass plants can take as long as four months to fully rejuvenate. Under less than ideal conditions, such as cold, shortened days due to the onset of fall or winter, or too much or too little water, natural turf can take even longer to recover from damage to the roots of the plants. Also, natural turf is unsuitable for indoor or, in some cases, partially enclosed stadiums, due to lack of sunlight.

To address these inherent limitations of natural turf, synthetic athletic fields have been developed. Back in the 1960s, with the advent of the first indoor stadium, fans and athletes were exposed for the first time to a “rug-type” artificial turf field, e.g., AstroTurf®. While the artificial turf fields such as those disclosed in U.S. Pat. No. 3,332,828 were very popular for a number of years, due to some distinct disadvantages, they enjoy only limited favor, in particular for the sport of field hockey. First, these types of artificial turf often change the nature and play of the sport being played on the surface. For example, a ball may roll farther and faster on this type of surface than it would on natural grass. Second, and perhaps more serious, many people attribute an increased number of athletic injuries to a corresponding artificial turf. This type of artificial turf can often be hard, causing athletes to feel as though they were running and falling on concrete. In addition to “rug burns” associated with exposed skin sliding across the artificial grass, more serious debilitating injuries were often suffered. In one study, it was found that foot and knee injuries on synthetic turf, in some cases, occurred about fifty percent (50%) more than on grass and, when the injuries did occur, they were often more serious and difficult to heal than those that occurred on grass. Larry Bernard, Artificial Turf Increases Football Ligament Injuries, Literature Search Shows, Cornell U. Science News, available at http://www.news.cornell.edu/science/Sept95/st.football.html (last visited May 30, 2002).

To overcome these deficiencies associated with synthetic surfaces, a number of companies have produced various filled-in artificial surfaces, with grasslike artificial fibers extending upwardly from a backing through a filled layer of particulate material, typically sand, as taught in U.S. Pat. Nos. 3,995,079 and 4,389,435. Unfortunately, as these fields age, deficiencies tend to arise due to the tendency of the infilled layer of sand to compact and become extremely hard.

To overcome the deficiency of sand-filled turf, another approach has been to vary the relative weights and percentages of the infilled materials, such as rubber and sand, and even layering these materials in a number of specific manners, as shown in U.S. Pat. No. 5,958,527. However, over time, there is a tendency for the rubber particles to migrate to the top layer of such infilled turf fields, causing dangerous “hard spots” to form. Thus, even if the field had feel and play characteristics which reasonably simulated natural grass shortly after installation, this situation deteriorates thereafter. As a result, the contact, feel, and roll of an athlete's foot on the turf will change as the field ages, and will become less and less like natural grass.

To address problems with using a sand infill, one synthetic turf incorporates a relatively short set of texturized nylon 6.6 fibers into a fiberglass backing with an infill of completely rubber particles. This structure is shown in U.S. Pat. No. 6,299,959. While this approach may solve some problems with sand infills, applicants believe there is still room for improvement in artificial turfs, primarily with respect to the goal of achieving a “foot feel” or foot roll which more closely simulates natural grass.

Another approach uses a dual-fiber knitted system comprised of approximately 1″ tall monofilament fibers and ½″ tall texturized monofilament fibers. A shallow layer of rubber granules covers the knitted fabric, which rests on a foam or other like energy-absorbing pad. Applicants again believe that there is still room for improvement and, in contrast to the prior art, use a different approach to address some of the deficiencies with artificial surfaces.

It is an object of the invention to improve upon infilled artificial surfaces so as to more closely simulate the “foot feel” and play characteristics of natural turf, including the natural balance between resiliency and firmness that a quality grass surface provides.

It is also an object of the invention to overcome compaction problems commonly associated with infilled artificial surfaces, and to do so in a long-lasting and durable manner.

It is still another objective of the invention to achieve, with an infilled artificial surface, a “foot feel” which closely resembles that of natural grass, wherein the surface also has a high degree of uniformity and durability.

It is another object of the invention to achieve a uniformly high quality grass-like artificial field with associated low maintenance costs.

### SUMMARY OF THE INVENTION

The present invention achieves these objectives by using a synthetic turf with two distinct groups of fibers extending upwardly from a backing, wherein a first upper group of fibers simulates natural grass plants and a second lower group consists of fibers that extend generally upwardly from the backing layer to the top, but not above, the fill, whereby substantially all of the fill layer is locked in, or stabilized. In the preferred embodiment, the stabilization of virtually the entire infilled layer is accomplished by the use of texturized fibers that, in an untexturized state may be equal to or even longer than the grass-like fibers, but once texturized, extend a shorter distance above a backing than the grass-like group of fibers. Each curl, bend, and twist of these texturized fibers provides increased stability throughout virtually the entire length, breadth, and depth of the particulate fill. However, while the stabilization of all of the fill is important, particularly to prevent particle migration and fill compressions, it is the increased stabilization at or near the top of the infilled layer which is critical to improving play characteristics.

By extending the stabilizing fibers to nearly the top of the infilled surface, the curls, bends, and twists of the fibers provide significant stabilization at or near the top surface of fill. In addition, since the ends of all fibers tend to fray and split over time, as the field ages, the fiber surface area near the top of the fill and the point of impact of balls, bodies, sticks, and shoes will actually increase. The increased stability of the top portion of the infilled layer helps to preserve the grass-like characteristics, prevent foot roll, and reduce the likelihood of turf-related injuries, such as injuries to the knee and ankle.

Foot roll occurs at the point where the shoe and the turf come together, and is caused by the firmness, or lack thereof, of the contact. By having a more stabilized infilled turf at the point of impact, the present invention reduces the likelihood of foot roll. Reducing foot roll will provide for a more realistic feel during the game and, for keenly observant fans, may also make a game played on this artificial surface seem as realistic as a competition on an all-natural grass field.

The likelihood of turf-related injuries is reduced because the artificial surface does not grab and “hold” an athlete's foot. Traditionally, artificial surfaces generally do not “give” like grass, and thus play-related injuries to an athlete's lower extremities tend to increase when a sport is played on an artificial surface. For example, an athlete who must cut and pivot often finds that his cleat remains in place, while his body does not, often resulting in leg and knee injuries. However, by stabilizing the top portion of the infilled layer, the present invention attempts to reduce the issue of undesirable foot retention and the higher risk of associated play injuries.

In contrast to applicants' approach, the prior art is concerned with stabilization or migration prevention at or near the backing, as shown by way of example in U.S. Pat. No. 6,299,959, or above the infilled layer, as shown by way of example in U.S. Pat. No. 6,338,885. Neither of these approaches, however, provides the stabilization where it is needed most. Moreover, considering the approach where all the fibers extend above the surface, given the same fiber density and length, this actually provides less stabilizing surface area within the infilled layer than does the present invention. For in the preferred embodiment, the texturized fibers, which in their pre-texturized state are approximately the same length as those extending above the top surface of the infilled layer, are all “underground.” In other words, given the same fiber density, when all fibers extend through the infilled layer, there is less fiber surface area to provide stabilization for the infilled layer.

In addition to these play-characteristic and injury-reducing benefits, the applicants have also achieved a more durable and long-lasting field for a number of reasons. First, the present invention provides a low-cost solution, both in terms of initial installation and long-term maintenance, over that of any other natural, natural/artificial combination, or current artificial turf fields available in the marketplace. The increased stabilization of the entire infilled layer causes it to tend to stay in the installation position and orientation, thus reducing the current problems of infilled layer migration where layers of sand and/or rubber intermix, stratify, and/or compact. This, in turn, provides lower periodic maintenance costs by reducing the need to realign, refill, or otherwise re-mix to achieve an ideal infilled composition. Moreover, since an entire group of the fibers is not exposed to the sun, those fibers will last longer. In outdoor stadiums, particularly in sunny climates, one of the greatest factors affecting the durability and life of the artificial turf is the exposure to ultraviolet radiation. Suppliers' warranties on their yarn are often shorter in sunny climates than for northern, more rainy, venues. By placing the second group of stabilizing fibers below the top surface of the infilled layer, the applicants have created a field comprised partially of fibers that will not be exposed to ultraviolet radiation, and thus will last longer than fibers subjected to constant exposure to the elements.

The accompanying drawing helps to explain the invention by illustrating a preferred embodiment of the invention.

### BRIEF DESCRIPTION OF THE DRAWING

The FIGURE is a side elevation illustrating the infilled artificial turf according to a preferred embodiment of the invention.

### DETAILED DESCRIPTION OF THE DRAWING

The drawing shows an artificial surface 10 in accordance with a preferred embodiment of the invention. The surface includes a base 11, which is typically constructed from a material such as gravel, asphalt, or concrete, commonly used in the construction industry for creating a firm, sturdy, generally smooth, and generally horizontal foundational surface. It is also possible that the base 11 could be formed using compacted soil, wood, or other foundational or flooring material, depending on the environment of the playing surface, namely whether it is indoor or outdoor. The drawing shows a non-woven backing 12 residing on top of the base 11 in a substantially horizontal orientation. A urethane or other like coating can be applied to the backing 12 to promote tuft bind. If desired, the base 11 and the backing 12 may be designed and configured to have a slope or inclination. This could be desirous in situations where the sport to be played on the field requires a unique feature such as a mound or hill, or where the particular geographical contour limits of the installation site necessitate adapting the field to an irregular grade.

The drawing further shows a layer of particulate material 14, which extends approximately 1⅝ to 2⅛ inches above the backing 12. As shown, the particulate material 14 comprises a homogenous fill. This fill could be composed of a single material or it could be a blend. Moreover, it is also possible that the particulate infilled layer 14 could be stratified. In other words, it could have different levels or layers composed of different types of materials or different blends of different materials.

The drawing also shows two groups of tufted fibers 16, 18. The first group of grass-like fibers 16 extend from the backing 12 through and above the infilled layer 14. In the preferred embodiment, these grass-like fibers 16 extend approximately 2 to 2½ inches above the backing 12 and the second group of fibers 18 are texturized and extend approximately 1½ to 2 inches above the backing 12. Generally, the grass-like fibers 16 extend approximately 3/8 to 1 inch above the second group of fibers 18 and will generally extend approximately 1/4 to 7/8 inches above the top surface 20 of the particulate material 14. The curls and bends 22 of these texturized fibers 18 stabilize the entire infilled layer 14.

In the preferred embodiment, the fibers 16, 18 are made of the same material, namely polyethylene. In alternative embodiments, the fibers could also be made from polypropylene, a co-polymer blend of polypropylene and polyethylene, or nylon. Moreover, each group of fibers 16, 18 could be made of a different material. For example, the grass-like fibers 16 could be made from polyethylene and the texturized stabilizing fibers 18 could be made from polypropylene. The fibers 16, 18 could also differ in stiffness in alternative embodiments.

In the preferred embodiment, the fibers 16, 18 are all fibrillated; however, in alternative embodiments, one or both groups could consist of fibers that could be a continuous slit or be extruded as a monofilament. Moreover, in the preferred embodiment, the fibers 16, 18 are all the same color, e.g., a grass-green color; however, in alternative embodiments, the fibers 16, 18, or a portion thereof, could be a different color, such as would be desirous for the requirements of the sport or for other aesthetic reasons. Similarly, the stabilizing fibers 18 may be produced in a color different than the grass-like fibers 16 to facilitate the filling and leveling process during installation and maintenance.

Having described the invention, I claim:

1. An infilled artificial surface comprising:
a base;
a backing residing on the base in a substantially horizontal orientation;
a plurality of fibers secured to the backing and extending generally upwardly therefrom, the plurality of fibers including a first group of grass-like fibers extending upwardly from the backing generally to a first vertical level above the backing and a second group of fibers extending upwardly from the backing generally to a second vertical level above the backing, located below the first vertical level; and
a particulate fill material residing on the backing and extending upwardly to the second vertical level, the particulate fill material including at least some resilient particles, whereby the resilient particles provide a cushioning effect for the artificial surface and the second group of fibers locks the fill layer in place to promote uniformity of the cushioning effect across the surface for an extended period of time.

2. The infilled artificial surface of claim 1 wherein the second group of fibers comprises texturized fibers.

3. The infilled artificial surface of claim 2 wherein the second group of texturized fibers comprises fibers that curl and twist in varying directions.

4. The infilled artificial surface of claim 1 wherein the second group of fibers are made of a different material than the first group of fibers.

5. The infilled artificial surface of claim 1 wherein at least one of the groups of fibers comprises fibrillated fibers.

6. The infilled artificial surface of claim 1 wherein at least one of the groups of fibers comprises continuous slit filament fibers.

7. The infilled artificial surface of claim 1 wherein at least one of the groups of fibers comprises monofilament extruded fibers.

8. The infilled artificial surface of claim 1 wherein at least one of the groups of fibers comprises fibers made from polypropylene.

9. The infilled artificial surface of claim 1 wherein at least one of the groups of fibers comprises fibers made from polyethylene.

10. The infilled artificial surface of claim 1 wherein at least one of the groups of fibers comprises fibers made from a co-polymer.

11. The infilled artificial surface of claim 1 wherein at least one of the groups of fibers comprises fibers made from a co-polymer combination of polypropylene and polyethylene.

12. The infilled artificial surface of claim 1 wherein at least one of the groups of fibers comprises fibers made from nylon.

13. The infilled artificial surface of claim 1 wherein one group of fibers comprises fibers of a softer material than the other group of fibers.

14. The infilled artificial surface of claim 1 wherein at least one of the groups of fibers is tufted to the backing.

15. The infilled artificial surface of claim 1 wherein one group of fibers comprises fibers of a different color than the other group of fibers.

16. The infilled artificial surface of claim 1 wherein the particulate fill material is comprised of rubber.

17. An infilled artificial surface comprising:
a base;
a backing residing on the base in a substantially horizontal orientation;
a plurality of fibers secured to the backing and extending generally upward therefrom, the plurality of fibers including a first group of polyethylene non-texturized grass-like fibers extending upwardly from the backing generally to a first vertical level located about 2 to 2½ inches above the backing and a second group of polypropylene texturized fibers extending generally upwardly with curls and twists in various directions from the backing generally to a second vertical level located about 1½ to 2 inches above the backing; and
a particulate rubber fill material residing on the backing and extending upwardly to about the second vertical level, the particulate rubber fill providing a cushioning effect for the artificial surface and the second group of fibers locking the fill material in place, thereby promoting a consistent, uniform and long-lasting cushioning effect across the surface.

18. The infilled artificial surface of claim 17 wherein at least one of the groups of fibers comprises fibrillated fibers.

19. The infilled artificial surface of claim 17 wherein at least one of the groups of fibers comprises continuous slit filament fibers.

20. The infilled artificial surface of claim 17 wherein at least one of the groups of fibers comprises monofilament extruded fibers.

21. An infilled artificial surface comprising:
a base;
a backing residing on the base in substantially horizontal orientation;
a plurality of grass-like fibers secured to the backing and extending generally upwardly therefrom to a first vertical level above the backing; and
a resilient means for promoting upward extension of the grass-like fibers and providing cushion for the artificial surface, said resilient means located above the backing and extending upwardly to a second vertical level located below the first vertical level.

22. The infilled artificial surface of claim 21 wherein the resilient means further comprises:
a particulate fill material residing on the backing and extending to the second vertical level; and
a second group of fibers extending generally upward from the backing.

23. A method for creating an infilled artificial playing surface comprising the steps of:
placing an artificial turf on a base, the artificial turf having a backing and a plurality of fibers secured thereto, the fibers further including a first group of fibers extending upwardly from the backing generally to a first vertical level above the backing and a second group of fibers extending upwardly from the backing generally to a second vertical level above the backing, located below the first vertical level; and
filling a particulate material onto the backing to a depth about equal to the second vertical level, the particulate material including at least some resilient particles, the second group of fibers substantially stabilizing the particulate material to provide a durable, uniform, and long-lasting artificial surface.
